(19) United States
(12) Patent Application Publication
(10) Pub. No.: US 2016/0236553 A1
(43) Pub. Date: Aug. 18, 2016

(54) COVER SYSTEM FOR A LOAD BED OF A VEHICLE

(71) Applicants: Andrew STEWART, Lake Orion, MI (US); Huan TRAN, Ostfildern (DE); Herbert WALTER, Ebersbach (DE); Markus HINTENNACH, Baltmannsweiler (DE); Mickey HANNAN, Shelby Township, MI (US)

(72) Inventors: Andrew STEWART, Lake Orion, MI (US); Huan TRAN, Ostfildern (DE); Herbert WALTER, Ebersbach (DE); Markus HINTENNACH, Baltmannsweiler (DE); Mickey HANNAN, Shelby Township, MI (US)

(21) Appl. No.: 15/013,352

(22) Filed: Feb. 2, 2016

Related U.S. Application Data
(60) Provisional application No. 62/115,710, filed on Feb. 13, 2015.

(51) Int. Cl. B60J 7/08; B60P 7/04

(52) U.S. Cl. CPC B60J 7/085; B60P 7/04

(57) ABSTRACT

A cover system for a load bed of a vehicle having a winding shaft mounted rotatably in a support structure, a flexible flat structure mounted on the winding shaft for winding up and unwinding between a rest position and a covering position and connected to a pull-out profile on its front end region remote from the winding shaft. Two guide rail arrangements are provided on opposite sides of the flat structure in which guide rail arrangements the pull-out profile is guided. Each guide rail arrangement has a hollow profile provided with a plurality of cavities which run along the hollow profile, are open or closed toward the flat structure and have guiding or receiving functions for the pull-out profile of the flat structure and a drive transmission.

### CROSS-REFERENCE TO RELATED APPLICATIONS

This claims the benefit of U.S. Provisional Application No. 62/115,710, filed Feb. 13, 2015.

### FIELD OF THE INVENTION

The invention relates to a cover system for a load bed of a vehicle having a winding shaft which is rotatably mounted in a support structure, having a flexible flat structure which is mounted such that it can be wound up and unwound on the winding shaft between a rest position and a covering position, and which is connected to a dimensionally stable pull-out profile on its front end region which lies away from the winding shaft, and having two guide rail arrangements on opposite sides of the flat structure, in which the pull-out profile is guided longitudinally displaceably.

### BACKGROUND OF THE INVENTION

DE 199 44 948 C1 has disclosed such a cover system for a load space of a passenger motor vehicle. The known cover system has a flexible flat structure which is mounted on a winding shaft such that it can be wound up and unwound. The winding shaft is mounted rotatably in a cassette housing which is mounted on the vehicle. A front end region of the flexible flat structure which is designed as a covering tarpaulin is provided with a dimensionally stable pull-out profile which is mounted on its end sides which lie opposite one another such that it can be displaced in two guide rails which extend in the vehicle longitudinal direction and are mounted fixedly on the vehicle. A winding spring arrangement is integrated into the winding shaft, which winding spring arrangement exerts a torque on the winding shaft in the winding-up direction. The pull-out profile is held on its opposite front end in in each case one driving slide which is guided longitudinally displaceably in the respective guide rail. Drive transmission means in the form of flex-shafts are provided for displacing the driving slides in the guide rails, which drive transmission means can be actuated synchronously with respect to one another via an electric motor.

### SUMMARY OF THE INVENTION

It is an object of the invention to provide a cover system of the type mentioned at the outset, which cover system has improved functions in the area of guide rail arrangements.

This object is achieved by virtue of the fact that each guide rail arrangement has a dimensionally stable hollow profile which is provided with a plurality of cavities which run along the hollow profile, are open or closed toward the flat structure and have guiding or receiving functions for the pull-out profile of the flat structure and the drive transmission means. A plurality of functions can be integrated into each guide rail arrangement by way of the solution according to the invention, with the result that a particularly compact and nevertheless functionally versatile cover system can be achieved. The hollow profile is preferably produced as a single-piece or multiple-piece extruded metal profile. The invention is used for load beds which are open toward the surroundings, that is to say they are exposed to ambient influences such as wind and water or snow and ice.

The solution according to the invention is suitable in a particularly advantageous way for an open load bed of a pickup passenger motor vehicle. In the same way, the cover system according to the invention can also be used for open load beds of other wheeled or tracked vehicles or of rail vehicles.

In one refinement of the invention, the hollow profile is split into a structure section with the guiding and receiving functions and into a covering section which forms an upper side of the hollow profile and is connected releasably to the structure section. Simple mounting of the covering section is made possible by way of the releasable arrangement of the covering section which forms an upper side of the respective guide rail arrangement, as a result of which access to the corresponding guiding and receiving functions of the structure section is achieved. As a result, there is the possibility of operator-friendly repairs and maintenance and adjustment measures.

In a further refinement of the invention, the covering section and the structure section are connected releasably to one another along an at least largely horizontal dividing plane. It is possible as a result to perform maintenance on the cover system or handle it in another way even in an operating state, in which it is mounted in the region of a load bed of a vehicle, by way of removal of the at least one covering section, since the covering section can be raised upward in a simple way.

In a further refinement of the invention, connecting means which can be handled without tools are provided between the covering section and the structure section. This ensures particularly simple mounting and dismantling of the respective covering section of the hollow profile of each guide rail arrangement.

In a further refinement of the invention, the connecting means comprise spring clamping elements. Clamps made from spring steel which are produced in one piece by way of stamping and/or bending processes can be provided as spring clamping elements. A plurality of spring clamping elements are preferably provided over the length of each guide rail arrangement, which spring clamping elements are arranged distributed uniformly over the length of the hollow profile of each guide rail arrangement.

In a further refinement of the invention, the structure section has, in the region of the dividing plane, water guiding means and water discharge openings which are designed in such a way that, during operation of the cover system, water which strikes the flat structure is discharged via the structure section laterally to the outside to an outer side of the hollow profile, which outer side lies away from the flat structure. This refinement is particularly advantageous for the use of the cover system in the region of load beds which are open toward the surroundings, as can occur in the case of pickup passenger motor vehicles, in the case of trucks, other commercial vehicles or else in the case of rail cars. In addition, the simple removal of the respective covering section makes particularly simple cleaning of corresponding water discharge paths possible. This is because the water discharge paths which are defined by the water guiding means and the water discharge openings are preferably provided in the region of the dividing plane between the covering section and the structure section.

In a further refinement of the invention, the structure section comprises, as cavities, a lateral guiding channel for lateral guiding elements of the flat structure and a drive channel for a guide of a drive body of the pull-out profile, which drive body is connected to the drive transmission means, and a receiving region for the drive transmission means. If the drive transmission means are configured as cable pulls, firstly corresponding wire cable sections of the cable pull run in the receiving region and secondly at least one deflection roller is mounted rotatably in the receiving region.

In a further refinement of the invention, the covering section is provided with a guide groove for guiding in each case one sliding body of transverse bows. It is possible as a result to guide transverse bows, which achieve a transverse reinforcement of the flat structure, securely and stably in the guide rail arrangements which lie opposite one another.

### BRIEF DESCRIPTION OF THE DRAWINGS

Further advantages and features of the invention result from the claims and from the following description of one preferred exemplary embodiment of the invention which is shown using the drawings, in which:

FIG. 1 diagrammatically shows a pickup passenger motor vehicle with one embodiment of a cover system according to the invention for the load bed of the pickup,

FIG. 2 shows the cover system according to FIG. 1 in a completely pulled-out covering position,

FIG. 3 shows a greatly enlarged, diagrammatic cross-sectional illustration of a part region of a flat structure of the cover system according to FIG. 2 in the region of a transverse bow,

FIG. 4 shows a further embodiment of a flat structure for a cover system according to FIG. 2 in a cross-sectional illustration with a transverse bow which lies on the outside,

FIG. 5 diagrammatically shows a sectional illustration of a rear-side closure of the load bed, a pull-out profile of the flat structure being provided with an elastic hollow profile seal,

FIG. 6 diagrammatically shows a sectional illustration of a winding-up region of a winding shaft of the cover system according to FIGS. 1 to 5,

FIG. 7 diagrammatically shows the winding up of a flat structure, provided with transverse bows, of the cover system according to FIGS. 1 to 6 in a partially wound-up state,

FIG. 8 diagrammatically shows a cross section through a guide rail arrangement of the cover system according to FIGS. 1 and 2 in the region of a side wall of the load bed of the pickup,

FIG. 9 shows a detail of the cover system according to FIGS. 1 to 8 in the region of the guide rail arrangement according to FIG. 8,

FIG. 10 shows an exploded illustration of a part region of the cover system according to FIGS. 1 to 9,

FIG. 11 shows an enlarged exploded illustration of an end side of a transverse bow of a flat structure of the cover system according to FIG. 10,

FIG. 12 shows a perspective sectional illustration of a detail of the cover system in the region of a guide rail arrangement which lies opposite the guide rail arrangement according to FIG. 9,

FIG. 13 diagrammatically shows the guide rail arrangement according to FIG. 12 in a cross-sectional illustration with an illustration of a lateral guide function for the flat structure,

FIG. 14 shows the illustration according to FIG. 13 with an additional pictorial illustration of a water discharge function,

FIG. 15 shows an exploded illustration of the guide rail arrangement according to FIGS. 12 to 14 with a covering section and a structure section,

FIG. 16 shows the opposite guide rail arrangement according to FIGS. 8 and 9 in an exploded illustration, in which a spring clamping element for fixing the covering section on the structure section can be seen,

FIG. 17 diagrammatically shows a longitudinal sectional illustration through a winding shaft of the cover system according to FIGS. 1 to 16, which winding shaft is provided with an electric drive system, and

FIG. 18 shows the drive system for the winding shaft according to FIG. 17 in an exploded illustration.

### DETAILED DESCRIPTION

A wheeled vehicle in the form of a pickup passenger motor vehicle 1 has a passenger cell with front and rear seats in a front region. Toward a rear of the pickup passenger motor vehicle, the passenger cell is adjoined by a load bed 2 which is delimited on all sides by upwardly protruding walls 3 to 5. The load bed 2 has a substantially horizontal load floor. A front wall 5 which is extended in the vehicle transverse direction, is guided upward at a right angle with respect to the load floor and is arranged immediately behind the passenger cell protrudes on the front side from the load floor. Opposite longitudinal sides of the load bed 2 are formed by two side walls 4 which are extended in the vehicle longitudinal direction and likewise protrude upward from the load floor. The side walls 4 open on the rear side into a rear wall 3 which is extended in the vehicle transverse direction and forms a rear-side termination of the load bed 2 which is open at the top. The rear wall 3 is provided in a manner which is not shown with a tailgate which can be folded rearward and downward, in order to make rear-side access to the load bed 2 possible.

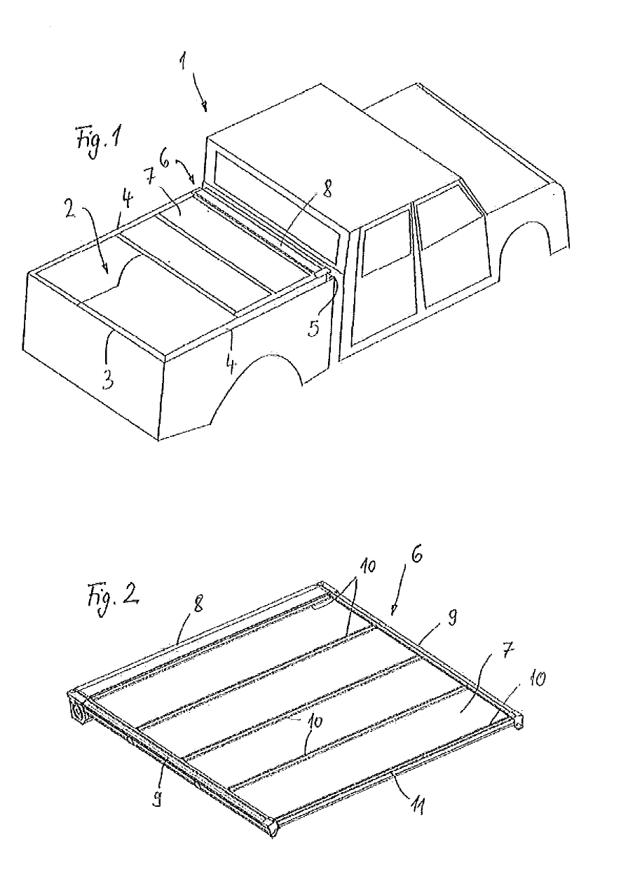

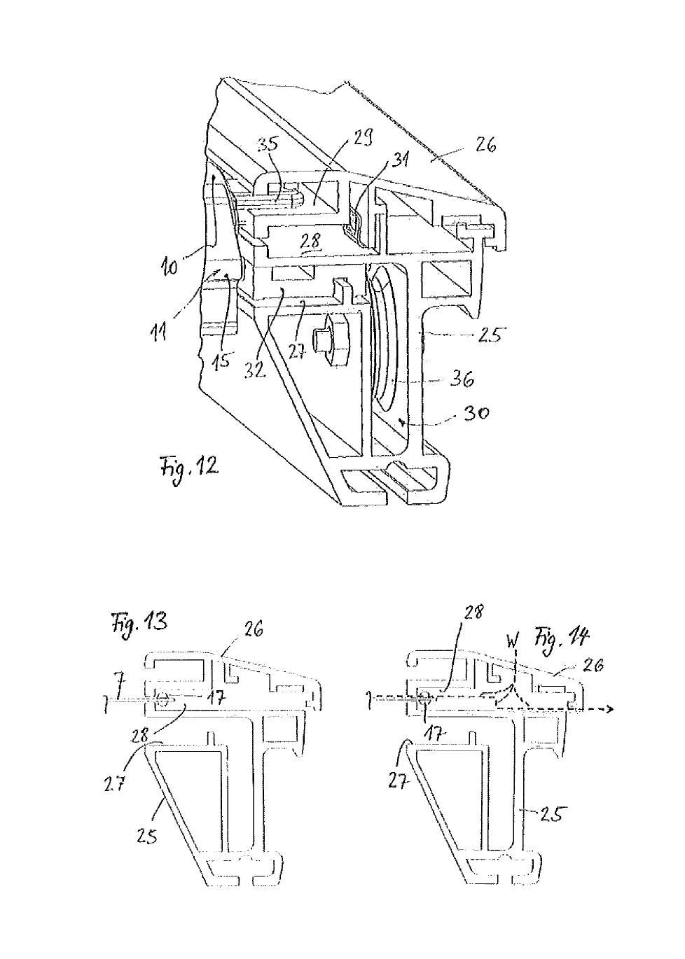

In order for it to be possible to close the load bed 2 in an upper edge region of the walls 3 to 5, a cover system 6 is provided which will be described in greater detail in the following text using FIGS. 2 to 18. The cover system 6 has a tarpaulin-like, flexible flat structure 7 which is held on a winding shaft 16 such that it can be wound up and unwound. The winding shaft is mounted rotatably in a cassette housing 8 which serves as support structure, the cassette housing 8 being mounted in the region of the front wall 5 in the mounted state in the region of the load bed 2 of the pickup passenger motor vehicle 1. To this end, the front wall 5 has a cutout which is indicated in FIG. 1 and into which the cassette housing 8 is inserted in a flush manner. In the mounted operating state of the cover system 6, the winding shaft 16 and therefore also the cassette housing 8 extend in the vehicle transverse direction over a width of the load bed 2.

Two guide rail arrangements 9 which are connected to the front end regions of the cassette housing protrude parallel to one another from opposite front end regions of the cassette housing 8 in the pull-out direction of the flat structure 7. In the mounted operating state of the cover system 6, the guide rail arrangements 9 protrude rearward in the vehicle longitudinal direction from the cassette housing 8 as far as toward the rear wall 3, the guide rail arrangements 9 flanking the flat structure 7 on its longitudinal sides which lie opposite one another.

As can be seen using FIG. 8, each guide rail arrangement 9 is connected fixedly via at least one fastening fitting 23 and corresponding fastening screws 24 to the corresponding side wall 4 of the load bed 2. Here, first of all the respectively corresponding fastening fitting 23 is fastened to the side wall 4 by way of corresponding fastening screws 24, before subsequently the guide rail arrangement 9 is placed onto the at least one fastening fitting and is connected to the latter via floor-side fastening screws 24. The cassette housing 8 and the guide rail arrangements 9 form the stationary sections of the cover system 6, which stationary sections are connected fixedly via corresponding mechanical fastening means, such as, in particular, the fastening fittings 23, to the walls 4, 5 of the load bed 2 of the pickup passenger motor vehicle 1.

The flexible flat structure 7 which is formed by a single-layer or multiple-layer textile or film web is reinforced over its length by way of a plurality of transverse bows 10, 10a which are positioned at uniform spacings from one another. The transverse bows 10, 10a have a convexly curved, arcuate cross-sectional profile, as can be seen clearly using FIGS. 3 to 7. The transverse bows 10, 10a are of dimensionally stable design and extend over an entire width of the flat structure 7 in the vehicle transverse direction, in relation to the mounted operating state of the cover system 6. The transverse bows are oriented relative to the flat structure 7 in such a way that the convex curvature of the transverse bows 10, 10a protrudes upward in the horizontally pulled-out covering position of the flat structure 7 (FIG. 2), whereas the correspondingly concave curvature protrudes toward the load floor of the load bed 2. All the transverse bows 10 are connected in a positively locking manner via weather strip connections 12, 13 to the flat structure 7. To this end, corresponding connecting sections 7′ which extend in each case over a width of the flat structure 7 have in each case one weather strip 13 which is pulled into in each case one weather strip groove 12 which is extended in the longitudinal direction of the transverse bows 10, 10a, and therefore in the vehicle transverse direction in the mounted state. The connecting sections 7′ of the flat structure 7 are connected fixedly to the flat structure 7 in the region of seams 140, 140′, in particular by way of welding, sewing or in another way.

As can be seen using FIGS. 3 to 7, two different variants are provided, in order to reinforce the flat structure 7 by way of the transverse bows 10, 10a transversely with respect to the pull-out direction. In the embodiment according to FIGS. 3 and 6, the transverse bows 10a are arranged in the region of an underside of the flat structure 7, that is to say on a side of the flat structure 7 which faces the load floor of the load bed 2. To this end, the connecting sections 7′ are connected fixedly in the region of seams 140 to the flat structure 7. The connecting sections 7′ are guided on the outside around the convex curvature of the transverse bow 10a and are fixed in a positively locking manner in two lateral weather strip grooves 12 with the aid of corresponding weather strip cords 13.

In the embodiment according to FIGS. 4, 5 and 7, the connecting sections 7′ are fastened via seams 140′ in the region of an upper side of the flat structure 7 and, including a common weather strip cord 13, protrude upward from the upper side of the flat structure 7. In this variant, the corresponding transverse bow 10 is positioned visibly on the upper side of the flat structure 7 and is connected in a positively locking manner via a middle, centrally arranged weather strip groove 12 to the connecting sections 7′ and the weather strip cord 13 of the weather strip connection.

Each transverse bow 10, 10a is manufactured as a dimensionally stable hollow profile made from metal or from plastic, preferably in an extrusion process or an injection molding process.

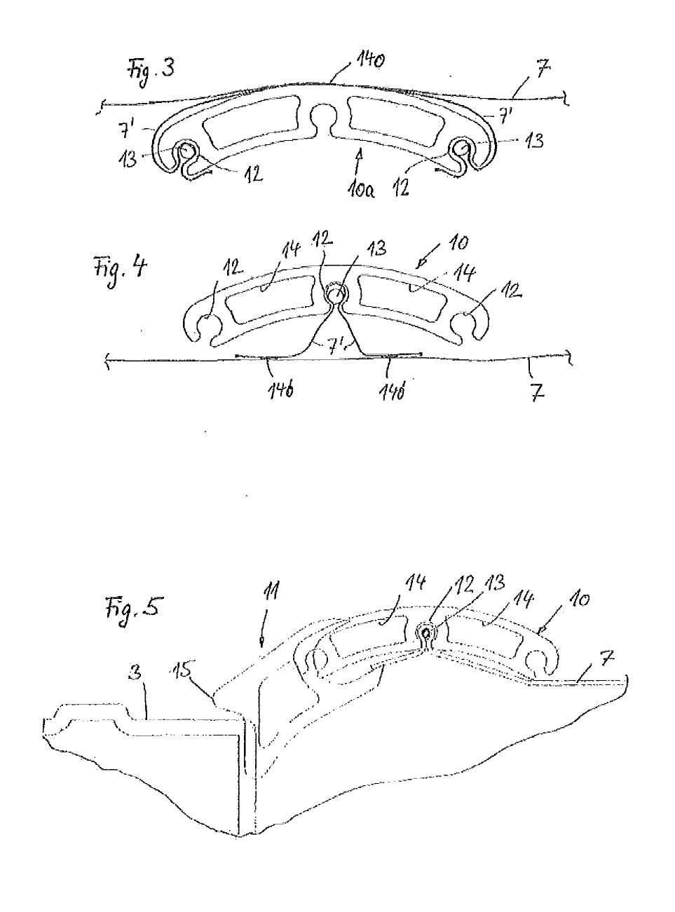

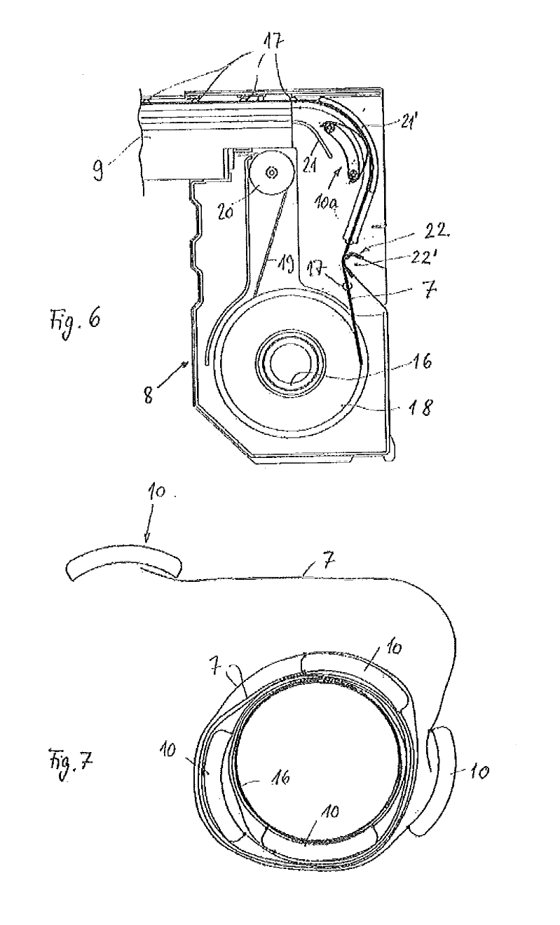

All the transverse bows 10, 10a are designed identically to one another. A transverse bow 10 (FIGS. 2 and 5) which is arranged on the end side in the pull-out direction on a front end region of the flat structure 7 is additionally provided on a longitudinal side which lies away from the flat structure 7 with a hollow profile seal 11 which extends over an entire length of the transverse bow 10. The hollow profile seal 11 is formed in one piece from an elastomer body and can be deformed elastically. The hollow profile seal 11 has a water discharge lug 15 which, in the pulled-out covering position of the flat structure 7 (FIGS. 2 and 5), protrudes rearward beyond an upper edge of the rear wall 3. In the covering position, in which the load bed 2 is closed completely, the hollow profile seal 11 bears sealingly against the rear wall 3 in an elastically deformed manner in the region of a corresponding boundary edge of said rear wall 3, the water discharge lug 15 which is extended over the entire length of the hollow profile seal 11 being positioned above the upper edge of the rear wall 3 according to FIG. 5 and partially protruding obliquely rearward beyond the upper side of the upper edge of the rear wall 3. Accordingly, the hollow profile seal 11 forms a water-tight termination of the flat structure 7 with the rear wall 3 in the closed covering position of the flat structure 7.

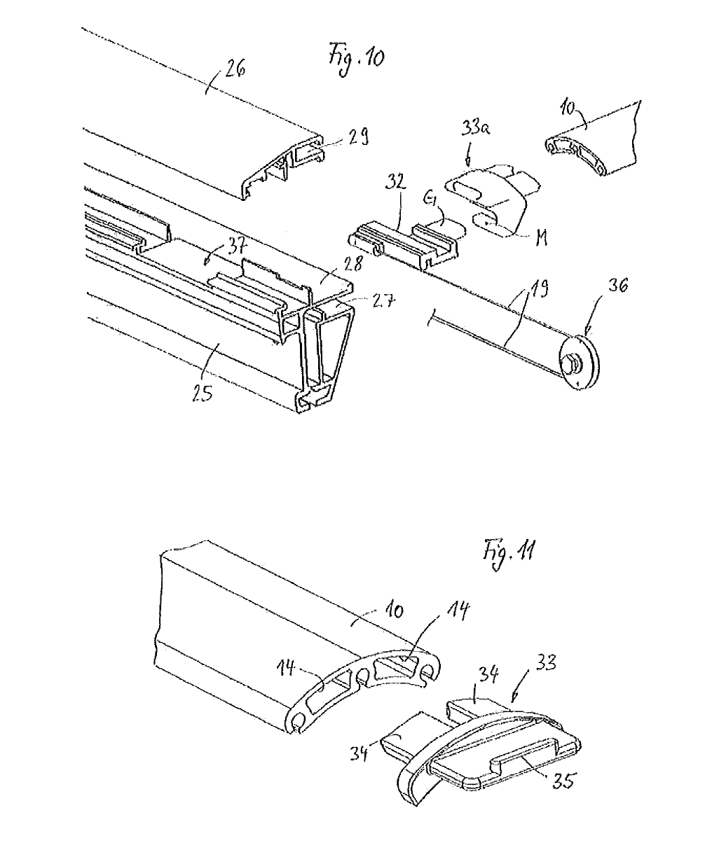

Each transverse bow 10, 10a is provided on its opposite end sides with in each case one sliding body 33 which can be plugged in a non-positive manner via plug-in profiles 34 in the form of plug-in journals into complementary, end-side plug-in profiles of the transverse bow 10, 10a in the form of plug-in sockets 14. The sliding body 13 forms an end-side termination of the end side of the respective transverse bow 10, 10a. All the transverse bows 10, 10a are provided in each case with corresponding sliding bodies 33 on their end sides which lie opposite one another, as can be seen using FIG. 11. On an outer side which faces away from the transverse bow 10, 10a, each sliding body 33 has a horizontally extended guide blade (not denoted in greater detail) which is mounted in a guide groove 29 (which will be described in greater detail in the following text) of the respective guide rail arrangement 9 such that it can be moved slidingly along the guide rail arrangement 9. The guide blade is provided on the edge side with an upwardly protruding retaining cam 35 which ensures positively locking retention of the respective sliding body 33 in the vehicle transverse direction within the guide groove 29 of the guide rail arrangement 9.

Apart from one exception, the sliding bodies 33 of all the transverse bows 10, 10a are designed identically to one another. This is because the end-side transverse bow 10 which forms an end-side termination of the flat structure 7 is provided with a modified sliding body 33a. The sliding body 33a (FIG. 10) is provided with an additional driver lug M which protrudes downward in a hook-like manner and interacts in a positively locking manner with a corresponding web G of a drive body 32 in a manner which will be described in greater detail in the following text. On its end sides which lie opposite one another, the end-side transverse bow 10 has in each case one sliding body 33a of this type which is provided with a corresponding driver lug M.

In each case one drive body 32 is mounted longitudinally displaceably in each of the two guide rail arrangements 9, which drive body 32 is provided in each case with a corresponding web G which enters into a plug-in connection with the corresponding driver lug M in the pull-out direction of the flat structure 7. To this end, the hook-shaped driver lug M of each sliding body 33a is open to the rear toward the cassette housing 8, with the result that the corresponding web G can dip into the open side of the driver lug M, in order for it to be possible to drive the driver lug M and therefore the sliding body 33a in the pull-out direction in a positively locking manner. The plug-in connection which is produced as a result between the corresponding web G and the driver lug M has a force flow of such a magnitude that the plug-in connection between the sliding body 33a and the drive body 32 is not released even in the case of a movement in the opposite direction of the drive body 32 in the winding-up direction of the flat structure 7.

The two drive bodies 32 are mounted in each case in a drive channel 27 of the respective guide rail arrangement 9 such that they can be moved slidingly along the respective guide rail arrangement 9. As can be gathered from FIG. 8, the drive channel 27 is open toward the center of the load bed 2, that is to say toward the flat structure 7, which otherwise also applies to the guide groove 29. The drive channel 27 is adjoined laterally to the outside in the guide rail arrangement 9 by a receiving region 30 which serves to receive a drive transmission means which is configured as a cable pull 19, 36, 18, 20 (FIGS. 6 and 10) in the embodiment according to FIGS. 1 to 18. Both guide rail arrangements 9 are identical, but are designed so as to be mirror-symmetrical with respect to one another. In each case one cable pull is integrated into both receiving regions 30 of the guide rail arrangements 9 which lie opposite one another. Each cable pull is formed by a wire cable 19 which is deflected over a rear-side deflection roller 36 (FIG. 10) and a cassette housing-side deflection roller 20 and is held on a cable drum 18 which is coaxial with respect to the winding shaft 16. In this way, one end of the wire cable 19 is held on the cassette housing-side cable drum 18, whereas an opposite cable end of the wire cable 19 is connected fixedly to the respective drive body 32.

The respective deflection roller 36 is mounted in a stationary manner in the respective guide rail arrangement 9 such that it can be rotated. The receiving region 30, the drive channel 27 and the guide groove 29 extend continuously with a constant cross section over the entire length of the guide rail arrangement 9.

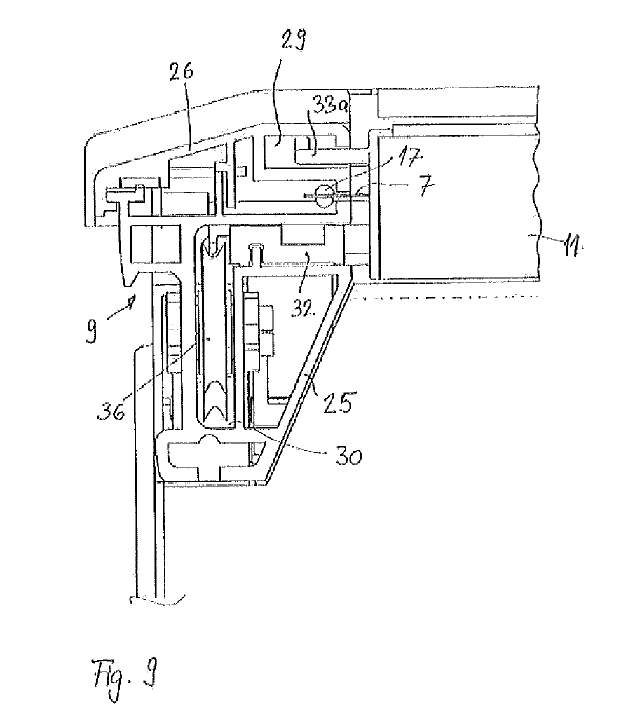

As can be gathered from FIGS. 9, 13 and 14, the flat structure 7 is additionally provided on its longitudinal sides which lie opposite one another with a multiplicity of lateral guide elements 17 which are designed as bead parts and are connected fixedly to the longitudinal edges of the flat structure 7. Here, the lateral guide elements 17 of in each case one longitudinal side of the flat structure 7 are positioned in a row behind one another in the pull-out direction. The lateral guide elements 17 protrude through the thickness of the flat structure 7 and protrude both to the upper side and to the underside of the respective longitudinal edge of the flat structure 7. The thickness (as viewed in the vehicle vertical direction) of the lateral guide elements 17 is accordingly substantially greater than a thickness of the flat structure 7. The lateral guide elements 17 are guided in a positively locking manner in the vehicle transverse direction in the region of each longitudinal side of the flat structure 7 in in each case one lateral guide channel 28 of the respective guide rail arrangement 9. Here, the longitudinal edges of the flat structure 7 protrude in each case transversely with respect to the pull-out direction through a corresponding longitudinal slot into the respective lateral guide channel 28 of the guide rail arrangement 9. Accordingly, the flat structure 7 is guided over its entire length with its lateral longitudinal edges which lie opposite one another in the guide rail arrangements 9 which lie opposite one another.

Each guide rail arrangement 9 is formed by a two-piece hollow profile made from lightweight metal alloy, preferably an aluminum extruded profile, or from a suitable plastic material. The hollow profile comprises a lower structure section 25 and an upper covering section 26 which are detached from one another or can be connected to one another along an approximately horizontal dividing plane. Both the structure section 25 and the covering section 26 are configured in each case as single-piece hollow profile bodies. The structure section 25 comprises the drive channel 27 and the receiving region 30 and a lower half of the lateral guiding channel 28. The covering section 26 comprises the guide channel 29 for the sliding bodies 33, 33a of the transverse bows 10, 10a. The covering section 26 is connected to one another via hook-in webs which are complementary with respect to one another and are not denoted in greater detail in the region of that outer side of the guide rail arrangement 9 which faces the side walls 4 and via central, vertically upward or downward protruding supporting webs which are likewise not denoted in greater detail. In the region of the vertical supporting webs, the joining together of the covering section 26 and the structure section 25 is assisted via a plurality of spring clamping elements 31 which serve as connecting means in the form of relief spring clamps which are bent in an S-shape. Here, the supporting webs which are assigned to the structure section 25 have cutouts 39, into which the spring clamping elements 31 can be inserted. The supporting webs of the covering section 26 are plugged in a simple manner from the top into the mounted spring clamping elements 31.

Accordingly, the respective covering section 26 can be connected to the associated structure section 25 without tools and can be dismantled again without tools in the same way. In the region of said dividing plane between the respective covering section 26 and the structure section 25, water discharge paths are provided distributed over the entire length of the hollow profile bodies, which water discharge paths, according to the diagrammatic illustration according to FIG. 14, can discharge water W, which strikes the flat structure 7 from above, laterally to the outside through the hollow profile bodies via the respective side wall 4 to the vehicle outer side. The water discharge paths are produced by way of water guide bevels 37 in the region of an upper side of the structure section 25 and by way of complementary water discharge openings 38 in the supporting web of the associated covering section 26. The water discharge bevels 37 are combined with cutouts (not denoted in greater detail) of the upwardly protruding supporting web of the structure section 25. The water discharge bevels 37 are lowered slightly obliquely downward from the middle of the upper side of the structure section 25 toward the outer side.

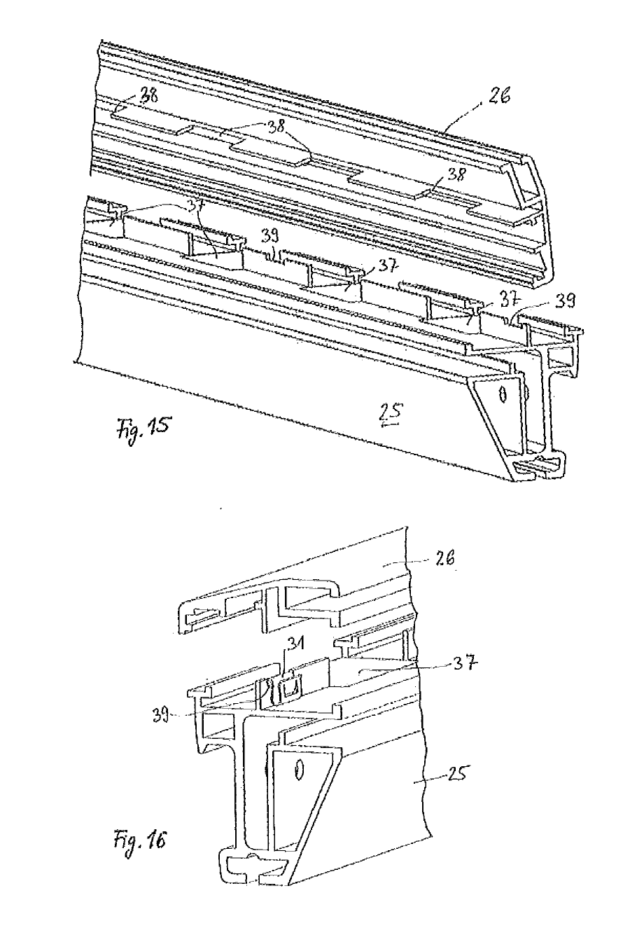

As can be seen using FIGS. 15 and 16, an outer-side side edge of the structure section 25 is also interrupted by corresponding openings in the region of the water discharge bevels 37, with the result that unimpeded discharging of water through said openings laterally to the outside is made possible.

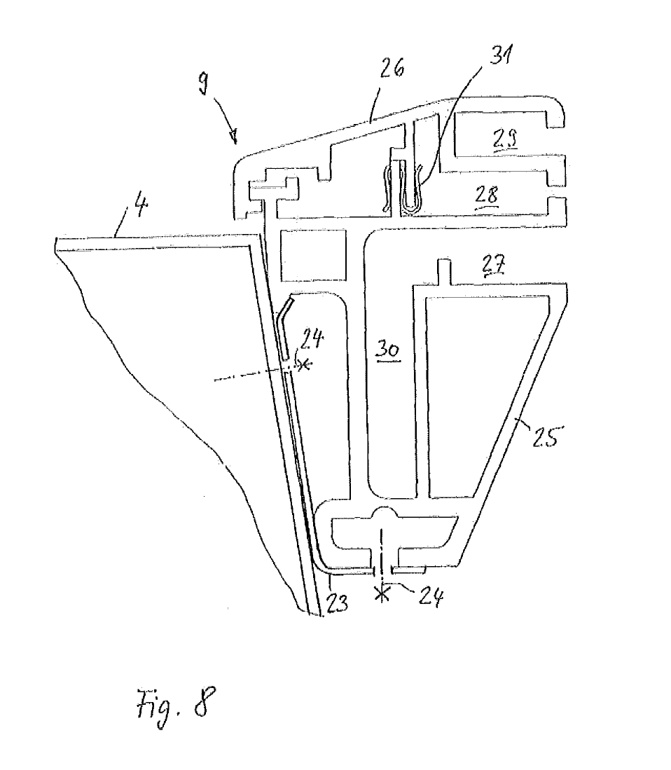

As can be seen using FIGS. 6 and 7, the flat structure 7 is wound onto the winding shaft 16 and is unwound from the latter. Here, in the winding-up region in the region of the cassette housing 8, the transverse bows 10, 10a are oriented with respect to the winding shaft 16 in such a way that the convex curvature of the transverse bows 10, 10a protrudes radially to the outside relative to a rotational axis of the winding shaft 16. Compact winding up of the flat structure 7 together with the transverse bows 10 is ensured as a result. In addition, the transverse bows 10, 10a are spaced apart from one another, as viewed in the pull-out direction of the flat structure 7, in such a way that, during winding up of the flat structure 7, the transverse bows 10 (FIG. 7) in the different winding layers are positioned in each case in a staggered manner with respect to one another. This means that in each case one transverse bow 10 of the respectively outer winding layer is positioned between two transverse bows 10 which are spaced apart from one another of a winding layer which lies radially further to the inside. This likewise ensures compact winding of the flat structure 7 onto the winding shaft 16.

In order to ensure that the transverse bows 10, 10a are wound onto the winding shaft 16 in a correct, space-saving orientation, deflection means 21, 21′, 22′ are provided which, according to FIG. 6, cause S-bend guidance of the flat structure 7 after exiting from the guide rail arrangement 9 and before being wound onto the winding shaft 16. The deflection means 21, 21′, 22′ are positioned in a stationary manner in the cassette housing 8. In addition, the deflection means 22′ comprises a cleaning strip 22 which cleans an upper side of the flat structure 7. To this end, the cleaning strip 22 has brushes or other mechanical cleaning elements in the region of its surface which interact mechanically with that surface of the flat structure 7 which slides past in the region of the deflection means 22′ and achieve a mechanical cleaning function as a result.

Each wire cable 19 is held such that it can be wound up and unwound in each case on a cable drum 18 which is positioned coaxially with respect to the winding shaft 16 on opposite ends of the winding shaft 16.

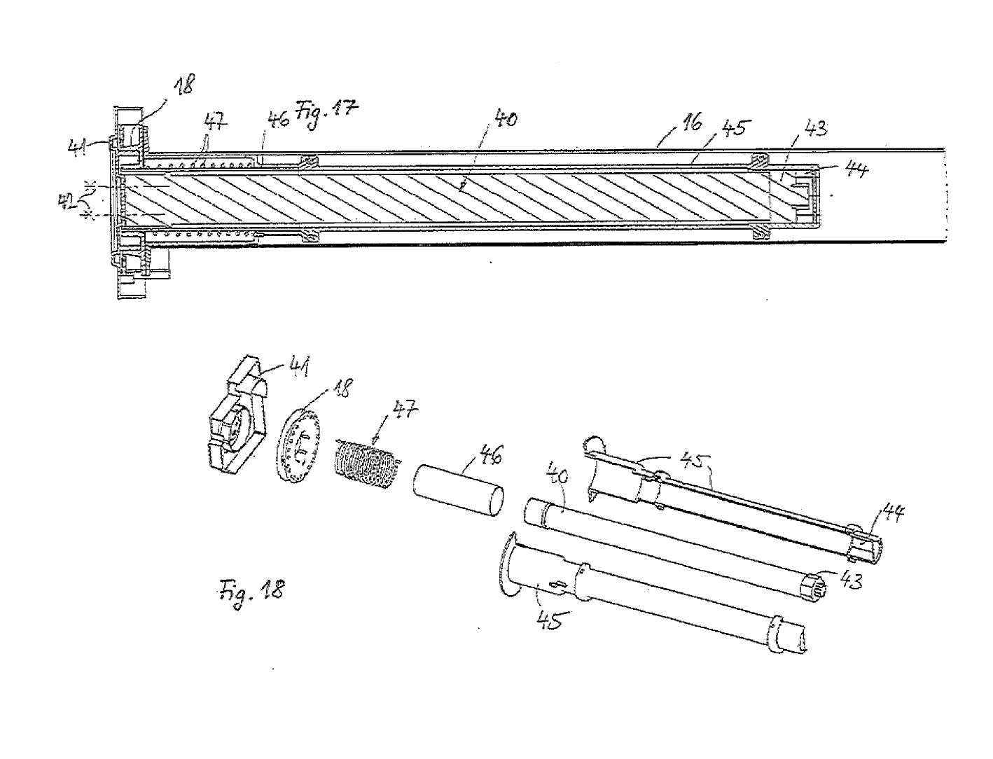

FIGS. 17 and 18 show merely one cable drum 18 on a front end region of the winding shaft 16. The cable drum which lies opposite is arranged in the same way and is in an operative connection with the winding shaft like the cable drum 18 which is shown using FIGS. 17 and 18. The cable drum 18 is mounted rotatably on an end 41 of the cassette housing 8. To this end, the end 41 has a rotary bearing ring (not denoted in greater detail), onto which the cable drum 18 is plugged. In addition, a stator part of a tubular motor 40 is fastened to the end 41, which tubular motor 40 protrudes coaxially into the winding shaft 16 which is designed as a rotationally symmetrical hollow profile. The stator part of the tubular motor 40 is connected fixedly on the end side to the end 41 of the cassette housing 8 via fastening means 42. In addition, the tubular motor 40 has a rotor part which is mounted in the stator part such that it can be rotated coaxially with respect to the rotational axis of the winding shaft and has a torque transmission section 43 which protrudes axially to the outside beyond the stator part and is connected in a rotationally locking manner to a motor housing 45. The rotationally locking connection of the torque transmission section 43 of the rotor part of the tubular motor 40 to the motor housing 45 takes place via a polygonal hollow profile section 44 of the motor housing 45, which hollow profile section 44 is adapted to the torque transmission section 43. The motor housing 45 is of two-shell construction, in order for it to be possible to achieve simple mounting and dismantling relative to the stator part and to the torque transmission section 43 of the tubular motor 40. Accordingly, the motor housing 45 is mounted rotatably relative to the stator part of the tubular motor 40. On its outer shell, the motor housing 45 is provided with integrally formed bearing rings which support the winding shaft 16 radially on the inside. In addition, the motor housing 45 has a cylindrical plug-in section which further assists a non-positive connection of an inner shell of the winding shaft 16 to the motor housing 45. Accordingly, the winding shaft 16 is connected in a rotationally locking manner to the motor housing 45.

A supporting tube 46 is pushed onto the tubular motor 40 on a front end region of the tubular motor 40, which front end region faces the end 41, on which supporting tube 46 a differential coil spring 47 in the form of a helical spring is arranged coaxially. The differential coil spring 47 is connected with one spring end to the motor housing 45 in a rotationally locking manner. The motor housing 45 surrounds the differential coil spring 45 coaxially on the outer side, whereas inner-side support takes place by way of the supporting tube 46. An opposite spring end of the differential coil spring 47 is connected to the cable drum 48 in a rotationally locking manner.

The cable drum 18 (not shown) which lies opposite on the end side is in an operative connection in the same way via a differential coil spring with the winding shaft 16, with the result that different rotational speeds between the cable drums 18 and the winding shaft 16 and, at the same time, stressing or relieving of the respective differential coil spring 47 can be achieved. Accordingly, the differential coil springs 47 make it possible to compensate for different circumferential speeds between the respective outer-side winding layers of the flat structure 7 depending firstly on the winding or unwinding state and secondly on the rotational movement of the cable drums. The motor housing 45 and the winding shaft 16 are connected to one another merely in a non-positive manner in the circumferential direction, with the result that slipping between the winding shaft 16 and the motor housing 45 is also made possible as soon as excessively high loads occur on the winding shaft 16. The tubular motor 40 is an electric motor and is supplied with electrical power via current and control lines which are not denoted in greater detail, and is controlled in a suitable way via an electric or electronic control unit. The tubular motor 40 can be rotated in both rotational directions, with the result that the winding shaft 16 can be loaded by the tubular motor 40 both in the winding direction and in the unwinding direction.

1. Cover system for a load bed of a vehicle having a winding shaft which is rotatably mounted in a support structure, having a flexible flat structure which is mounted such that it can be wound up and unwound on the winding shaft between a rest position and a covering position, and which is connected to a dimensionally stable pull-out profile on its front end region which lies away from the winding shaft, and having two guide rail arrangements on opposite sides of the flat structure, in which the pull-out profile is guided longitudinally displaceably, wherein each guide rail arrangement has a dimensionally stable hollow profile which is provided with a plurality of cavities which run along the hollow profile, are open or closed toward the flat structure and have guiding or receiving functions for the pull-out profile of the flat structure and the drive transmission means.

2. Cover system according to claim 1, wherein the hollow profile is split into a structure section with the guiding and receiving functions and into a covering section which forms an upper side of the hollow profile and is connected releasably to the structure section.

3. Cover system according to claim 2, wherein the covering section and the structure section are connected releasably to one another along an at least largely horizontal dividing plane.

4. Cover system according to claim 2, wherein connecting means which can be handled without tools are provided between the covering section and the structure section.

5. Cover system according to claim 4, wherein the connecting means comprise spring clamping elements.

6. Cover system according to claim 3, wherein the structure section has, in the region of the dividing plane, water guiding means and water discharge openings which are designed in such a way that, during operation of the cover system, water which strikes the flat structure is discharged via the structure section laterally to the outside to an outer side of the hollow profile, which outer side lies away from the flat structure.

7. Cover system according to claim 2, wherein the structure section comprises, as cavities, a lateral guiding channel for lateral guiding elements of the flat structure and a drive channel for a guide of a drive body of the pull-out profile, which drive body is connected to the drive transmission means, and a receiving region for the drive transmission means.

8. Cover system according to claim 2, wherein the covering section is provided with a guide groove for guiding in each case one sliding body of the transverse bows.
